(19) United States
(12) Patent Application Publication
(10) Pub. No.: US 2004/0190288 A1
(43) Pub. Date: Sep. 30, 2004

(54) Multi-purpose flashlight

(76) Inventor: You-Ching Hsu, Taipei (TW)

Correspondence Address: You-Ching Hsu, PO Box 82-144, Taipei, TW

(21) Appl. No.: 10/397,803

(22) Filed: Mar. 27, 2003

(51) Int. Cl. F21L 4/00; F21V 33/00

(52) U.S. Cl. 362/208; 362/253

(57) ABSTRACT

A multi-purpose flashlight functioning for self-defense, fire extinguishing, alarm and lighting all in one, is comprised of a body, an adapter and an extension; a light projection section adapted with a reflective board being provided at the head of the body; a light source being provided at the rear end of the body; a buzzer being provided at the terminal of the body help and alarm; light source push-button switch and buzzer switch being provided on the body; an adapter being provided

### BACKGROUND OF THE INVENTION

(a) Field of the Invention

The present invention is related to a multi-purpose flashlight and more particularly, to one that provides self-defense, help, alarm, fire extinguishing, and lighting functions all in one.

(b) Description of the Prior Art

Most of the flashlights generally available in the market provide only one function of lighting. While search for the source of fire, a fireman has to rely upon a light attached to his helmet before putting out the fire. When the thermal source of the flashlight is incorporated with the fire extinguisher, the fire extinguishing solution in the fire extinguisher will be volatized to render the fire distinguisher useless in case of a fire.

### SUMMARY OF THE INVENTION

The primary purpose of the present invention is to provide a multi-purpose flashlight that can be used for lighting, fire extinguishing, self-defense, calling for help and alarm all in one unit. To achieve the purpose, the present invention is comprised of a body, an adapter, and an extension. A source projection section attached with a reflective board is provided at the head of the body; and a light source generator behind the light projection section to generate lighting source taking advantage of-an energy source section at where a battery is appropriately accommodated in the body. A buzzer is provided at the tail of the body for calling help and alarm for the user. A PB switch is each respectively provided for the light source and the buzzer. A threaded adapter is provided at the tail of the body to be pivoted to the threaded front of the extension. A pivoting knob is provided to the adapter for adjusting the lighting angle. The adapter is wrapped up with expansion rubber. The extension relates to a longer hollow tube having provided at its fore section a filling hole to be injected into fire extinguishing solution, and a nozzle connected through the tube is provided at where appropriately on the outer wall of the extension.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a structure of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

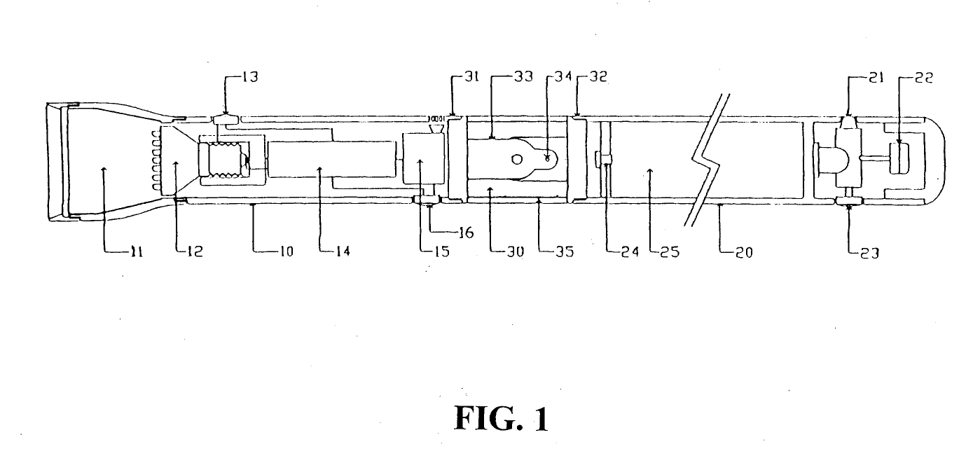

Referring to FIG. 1, the present invention contains a body 10, an extension 20 and an adapter 30. Wherein, a light projection area 11 at the head of the body 10 is provided with a reflective board to reflect the light. A cold light source generator 12, i.e., an LED is provided behind the light projection area 11. The temperature of the light emitted form the light source generator 12 is low enough to keep fire distinguishing solution from volatilized. A buzzer 15 is provided at the tail of the body 10 to operate on a battery 14. Two push-button switches 13, 16 are respectively provided for the light source 12 and the buzzer 15. The adapter 30 provided with a pivoting area 31 with its inner circumference threaded is disposed at the farthest tail end of the body 10. Another pivoting area 32 with its inner circumference threaded at the top of the extension 20 is engaged to the adapter 30 for the extension 30 to be integrated with the body 10. a pivoting knob 33 wrapped up with rubber is provided to the adapter 30 to adjust the angle of the body 10 as desired. The extension 20 comprised of a hollow tube 25 and a tail section, is longer than the body 10. A filling hole is provided at the rear end of the pivoting area 32 to be injected into the hollow tube 25 with a toxin free and odorless fire extinguishing solution. A nozzle 21 connected through the hollow tube 25 is provided in the tail section of the extension 20, and a press switch 23 is provided at where opposite to the nozzle. When the switch 23 is pressed, the fire extinguishing solution in the hollow tube 25 is sprayed out to put out the fire. A pressure gage 22 is provided at the farthest end of the extension 20 to observe the containment of the solution inside the hollow tube. The present invention is capable of putting out a fire when first contact in sight the user switches on the present invention to escape from the site where usually is dark and smoky. Meanwhile the buzzer 15 sounds alarm to people around. In case of a hold up, the present invention may serve an effective weapon for self-defenses. The present invention for providing multi-purpose functions is practice and innovative, therefore, this application for a utility patent is duly filed.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multi-purpose lighting installation functioning as a flashlight and a fire distinguisher comprising:
a body, having at its front provided with a light source projection area adapted with a reflective board, a light source generator being disposed behind the projection area, a battery being contained in the body, a buzzer being disposed at the tail of the body, a pivoting area having its inner circumference threaded being provided at the tail of the body, and a switch each being provided to the light source and the buzzer at where appropriately in the body;
an extension, in a length greater than that of the body being comprised of a hollow tube and a tail section, a pivoting area having its inner circumference threaded being provided at the front of the extension, a filling hole being provided in the surface of the pivoting area, a solution for fire extinguishing purpose being injected into the hollow tube, a nozzle connected through the hollow tube being provided on the external wall at the front end of the tail section, a corresponding press switch being provided at where opposite to the nozzle, and a pressure gage being provided at the farthest tail end to observe the level of the solution; and
an adapter, having at its both ends threaded to respectively engage to the pivoting area each from the body and the extension to incorporate the body and the extension into an integrated installation, a pivoting nozzle being provided to the adapter for adjusting the lighting angle as desired.
